(19) United States
(12) Patent Application Publication
(10) Pub. No.: US 2013/0031520 A1
(43) Pub. Date: Jan. 31, 2013

(54) FUNCTIONAL VERIFICATION SYSTEM FOR SEMICONDUCTOR INTEGRATED CIRCUIT, AND FUNCTIONAL VERIFICATION METHOD FOR SEMICONDUCTOR INTEGRATED CIRCUIT

(71) Applicant: Yoji ASAO, Kanagawa (JP)

(72) Inventor: Yoji ASAO, Kanagawa (JP)

(73) Assignee: KABUSHIKI KAISHA TOSHIBA, Tokyo (JP)

(21) Appl. No.: 13/419,301

(22) Filed: Mar. 13, 2012

(30) Foreign Application Priority Data
Jul. 27, 2011 (JP) 2011-164612

(51) Int. Cl. G06F 17/50

(52) U.S. Cl. 716/106

(57) ABSTRACT

A functional verification system for a semiconductor integrated circuit according to an embodiment includes: a stimulus generating section; a result determining section configured to compare an expected value expected to be obtained when the stimulus is input to a logic circuit to be verified and a predetermined operation is thereby performed, and an output value actually obtained as a result of a predetermined operation being performed, to determine whether or not the output value and the expected value correspond to each other; a state dumping section; and a state loading section configured to load the logic circuit state information stored in the storing device into the logic circuit to be verified only if the result determining section determines that the output value and the expected value do not correspond to each other.

### CROSS-REFERENCE TO RELATED APPLICATION

This application is based upon and claims the benefit of priority from the Japanese Patent Application No. 2011-164612, filed on Jul. 27, 2011; the entire contents of which are incorporated herein by reference.

### FIELD

Embodiments relate to a functional verification system for a semiconductor integrated circuit and a functional verification method for a semiconductor integrated circuit.

### BACKGROUND

In general, for functional verification of a semiconductor integrated circuit, especially, a logic circuit, random verification is used as a method for performing effective and high-quality verification. In random verification, a random stimulus is generated according to a test scenario defined in advance, and input to a logic circuit to be verified. If an output from the logic circuit is equal to an expected value, the logic circuit is determined to pass (hereinafter referred to as “Pass”) because the logic circuit has been built according to the specifications. However, if the output from the logic circuit is different from the expected value, the logic circuit is determined to fail (hereinafter referred to as “Fail”) because the logic circuit has not been built according to the specifications and has defects.

At an early stage of random verification operation which requires a period over several weeks, ordinarily, many random vectors result in Fail because of several functional bugs with a high probability of occurrence, resulting in stoppage of the verification. Accordingly, in conventional verification systems, the operation of performing verification again after bugs, which caused the Fail, are fixed is repeated, whereby bugs that are present in the logic circuit are sequentially detected.

As described above, the conventional verification systems are unable to detect bugs with a low probability of occurrence unless fixing is sequentially performed from bugs with a higher probability of occurrence. In other words, the conventional verification systems have to fix a logic circuit in the order of discovering bugs (in descending order of probability of occurrence), not the severity of the bugs, and thus, unable to detect important bugs involving a major change in design at an early stage of verification operation which requires a period over several weeks.

Therefore, where a bug involving a major change in structure and/or design of an important part of a logic circuit after bugs with a higher probability of occurrence are fixed spending time, the verification work and bug fixing work performed before are wasted, causing a problem of an increase in development time and cost.

### BRIEF DESCRIPTION OF THE DRAWINGS

FIG. 1 is a diagram illustrating an example of a configuration of a functional verification system for a semiconductor integrated circuit according to a first embodiment;

FIG. 2 is a configuration diagram illustrating an example of a configuration of a simulator 32.

FIG. 3 is a flowchart illustrating a specific procedure of functional verification of a logic circuit 322 by a functional verification system 1 according to the first embodiment;

FIG. 4 is a configuration diagram illustrating an example of a configuration of a simulator 32′ according to a second embodiment.

FIG. 5 is a diagram illustrating an example of a parameter table 327.

FIG. 6 is a flowchart illustrating a specific procedure of functional verification of a logic circuit 322 by a functional verification system 1 according to the second embodiment.

FIG. 7 is a diagram illustrating an example of a parameter table 327 at a certain point of a simulation.

FIG. 8 is a flowchart illustrating an example of a procedure for changing a range for a stimulus.

### DETAILED DESCRIPTION

A functional verification system for a semiconductor integrated circuit according to an embodiment includes: a stimulus generating section configured to generate a stimulus according to an input test scenario; a result determining section configured to compare an output value obtained by the stimulus being input to a logic circuit to be verified and a predetermined operation being thereby performed, and an expected value expected to be obtained where the stimulus is input to the logic circuit to be verified and a predetermined operation is thereby performed, to determine whether or not the output value and the expected value correspond to each other; a state dumping section configured to store values of all signals, registers and memory elements in the logic circuit to be verified, in a storing device as logic circuit state information at an arbitrary point of time from the generation of the stimulus to the input of the stimulus to the logic circuit to be verified; and a state loading section configured to load the logic circuit state information stored in the storing device into the logic circuit to be verified, wherein the state loading section loads the logic circuit state information into the logic circuit to be verified only if the result determining section determines that the output value and the expected value do not correspond to each other.

Embodiments will be described below with reference to the drawings.

### First Embodiment

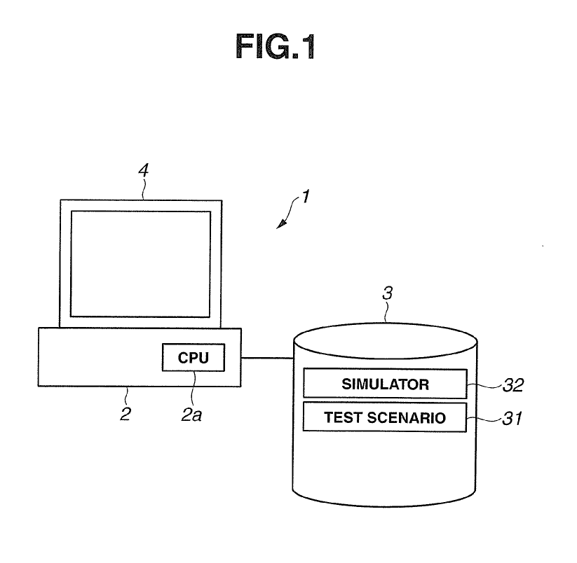

First, a configuration of a functional verification system for a semiconductor integrated circuit according to the present embodiment will be described with reference to FIG. 1. FIG. 1 is a diagram illustrating an example of a configuration of a functional verification system for a semiconductor integrated circuit according to the first embodiment.

A functional verification system 1 for a semiconductor integrated circuit includes a main body device 2 including a central processing unit (hereinafter referred to as the “CPU”) 2a configured to execute various software programs, a storing section 3 connected to the main body device 2, the storing section 3 being configured to store the various software programs, and a display section 4 connected to the main body device 2. Although not illustrated, input devices, such as a keyboard and a mouse, for a user to input instructions to execute the various programs are connected to the main body device 2.

In the storing section 3, a simulation program (hereinafter referred to as the “simulator”) 32 for performing functional verification of a semiconductor integrated circuit, in particular, a logic circuit, is stored as one of the various software programs. Furthermore, in the storing section 3, a test scenario 31 in which an arrangement of an entire test used for executing the simulator 32 is described is stored. The CPU 2a in the main body device 2 can execute or read these programs, etc., stored in the storing section 3.

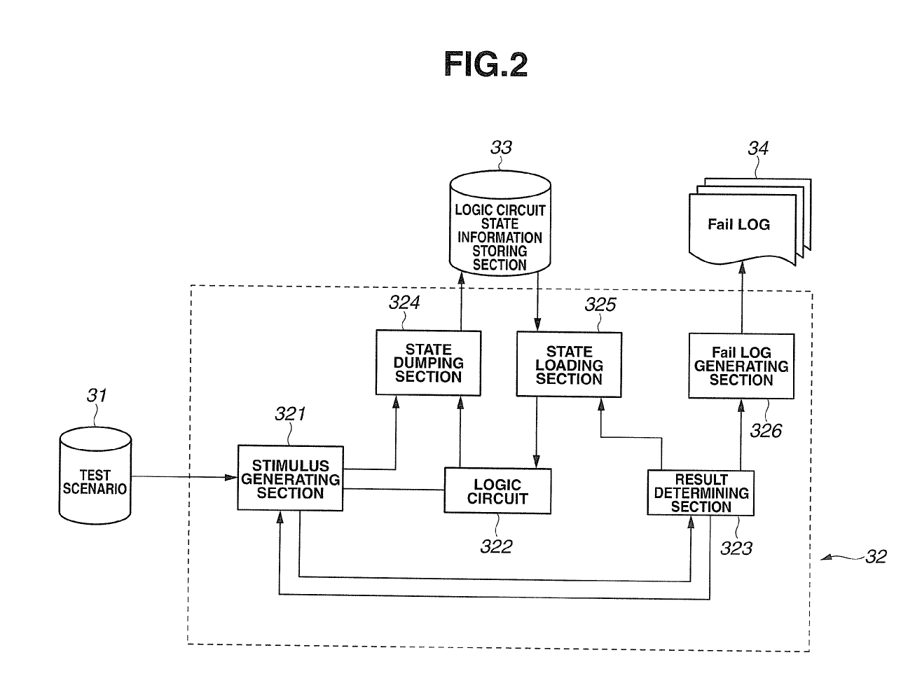

Next, a configuration of the simulator 32 will be described. FIG. 2 is a configuration diagram illustrating an example of a configuration of the simulator 32.

As illustrated in FIG. 2, the simulator 32 includes a stimulus generating section 321 configured to generate a random stimulus according to the test scenario 31, a result determining section 323 configured to determine a verification result, and a Fail log generating section 326 configured to, if the verification result is Fail, generate a Fail log 34. In the Fail log 34, information enabling identification of a situation in which the Fail occurred such as a content of the stimulus when the Fail occurred (for example, what command was given to which address), an output value, a difference between the output value and an expected value or the expected value, and simulation time is described. The Fail log 34 can be displayed on the display section 4, printed on, e.g., paper, or copied on another storage medium.

The simulator 32 also includes a state dumping section 324 configured to store values of all signals, registers and memory elements in a logic circuit 322 at an arbitrary timing in a simulation (hereinafter referred to as “logic circuit state information”), in a logic circuit state information storing section 33, and a state loading section 325 configured to load the logic circuit state information stored in the logic circuit state information storing section 33 into the logic circuit 322.

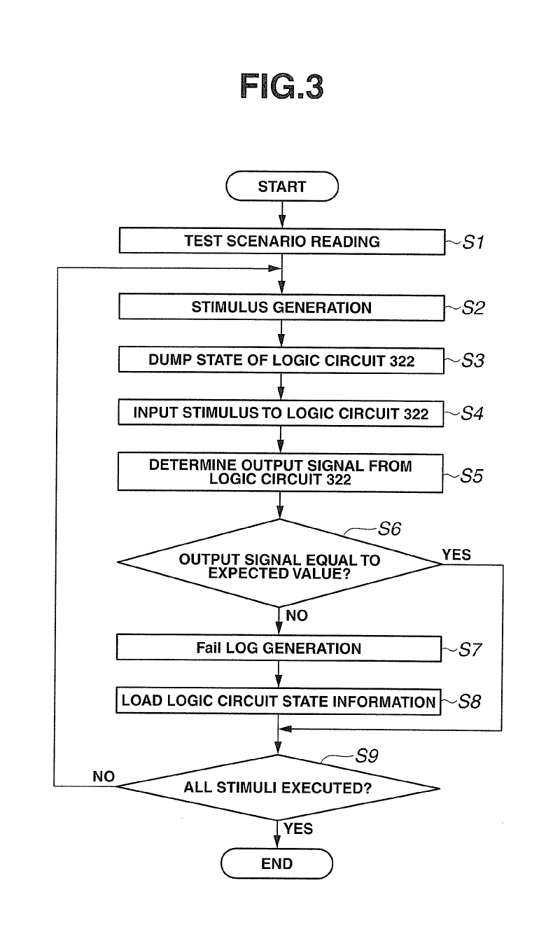

Next, an operation of the functional verification system 1 for a semiconductor integrated circuit according to the present embodiment will be described. FIG. 3 is a flowchart illustrating a specific procedure of functional verification of the logic circuit 322 performed by the functional verification system 1 according to the first embodiment. Here, a description will be given taking a case where random functional verification of the logic circuit 322 described using, for example, RTL, as an example.

First, in step S1, the test scenario 31 is read to the stimulus generating section 321 of the simulator 32. The stimulus generating section 321 generates a random stimulus according to the read test scenario 31 (step S2). Upon generation of the stimulus, the stimulus generating section 321 instructs the state dumping section 324 to dump a state of the logic circuit 322 (logic circuit state information) into the state dumping section 324.

Upon receipt of the dumping instruction from the stimulus generating section 321, the state dumping section 324 dumps the logic circuit state information on the logic circuit 322 at that point of time into the logic circuit state information storing section 33 (step S3).

Next, the stimulus generated in step S2 is input from the stimulus generating section 321 to the logic circuit 322 and the result determining section 323 (step S4). The logic circuit 322 operates according to a content of the stimulus, and an output value is transmitted to the result determining section 323. The result determining section 323 compares the output value from the logic circuit 322 and an expected value generated based on the stimulus transmitted from the stimulus generating section 321, to determine whether a result of the verification is Pass or Fail (step S5).

In step S6, if a determination is made that the output value from the logic circuit 322 is different from the expected value, that is, the result of the verification is Fail, the procedure process to step S7. In step S7, the result determining section 323 instructs the Fail log generating section 326 to generate a Fail log 34. The Fail log generating section 326 describes information enabling identification of a situation in which the Fail occurred (e.g., a content of the stimulus when the Fail occurred, e.g., what command was given to which address), the output value, the expected value or a difference between the output value and the expected value, simulation time) in the Fail log 34.

Next, the procedure proceeds to step S8, the result determining section 323 instructs the state loading section 325 to load the logic circuit state information. The state loading section 325 loads the logic circuit state information stored in the logic circuit state information storing section 33 into the logic circuit 322. In other words, with this step, the state of the logic circuit 322 returns to a state before the input of the stimulus that is a cause of the occurrence of the Fail.

In step S6, if a determination is made that the output value from the logic circuit 322 is equal to the expected value, that is, the result of the verification is Pass, the procedure proceeds to step S9 without generation of the Fail log 34 (step S7) and loading of the logic circuit state information (step S8).

If there is an unexecuted stimulus from among stimuli to be generated based on the test scenario 31 (step S9: No), the procedure proceeds to step S2, the stimulus generating section 321 generates an unexecuted new stimulus. Using the generated new stimulus, the above-described procedure from steps S3 to S8 is performed, whereby functional verification of the logic circuit 322 is continuously performed.

On the other hand, if all of the stimuli generated based on the test scenario 31 have already been executed, the verification of the logic circuit 322 is terminated (step S9: Yes).

As described above, in the present embodiment, even if a result of execution of a stimulus is Fail, the simulation is continuously performed by returning the state of the logic circuit 322 to a state before an input of the stimulus. Accordingly, not only bugs with a high probability of occurrence but also other bugs with a low probability of occurrence can be searched for and detected at one simulation. Furthermore, since information enabling identification of a situation at the time of occurrence of the Fail is described in a Fail log 34, a bug with a high degree of importance can be identified and a method for fixing the bug can be considered by analyzing the Fail log 34.

Conventionally, a simulation is stopped every time a bug is discovered, and thus, it is necessary to resume the simulation after fixing the discovered bug. Therefore, where a bug with a low probability of discovery but a high degree of importance (bug requiring a major change in structure and/or design in an important part of the logic circuit) exists, corrections made to the logic circuit to fix bugs with a high probability of occurrence before the discovery of such bug are wasted. However, in the present embodiment, various bugs can be detected at one simulation, and bugs can be fixed in descending order of importance, enabling reduction in development time and cost.

### Second Embodiment

While the functional verification system for a semiconductor integrated circuit according to the first embodiment described above executes a simulation for all stimuli generated according to a given test scenario 31, the present embodiment is different from the first embodiment in that a result of execution of a simulation is analyzed at a certain point of time during the simulation and a range for a stimulus to be generated is automatically updated. Components that are the same as those in the first embodiment are provided with reference numerals that are the same as those of the first embodiment, and a description thereof will be omitted.

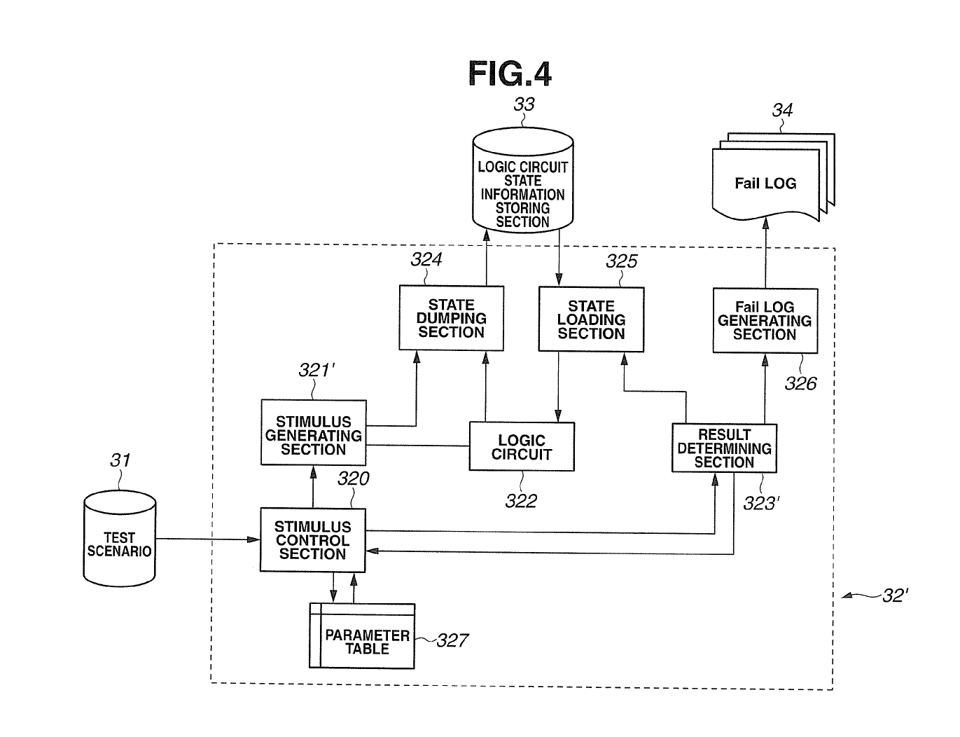

FIG. 4 is a configuration diagram illustrating an example of a configuration of a simulator 32′ according to the second embodiment. The simulator 32′ includes a stimulus control section 320 configured to control generation of a stimulus based on information input from a test scenario 31 and a verification result input from a result determining section 323′.

The stimulus control section 320 determines one or more types of parameters, which are to be controlled, and possible values each of the parameters has, according to the read test scenario 31. Here, a parameter is an element included in a stimulus, and more specifically, is, for example, a command such as those for a bus operation, an address or a timing of occurrence. Also, a matrix including the respective parameters as elements thereof is created, and held as a parameter table 327. The parameter table 327 is accessed by the stimulus control section 320, and used for analyzing a verification result to determine a range for generation of a stimulus.

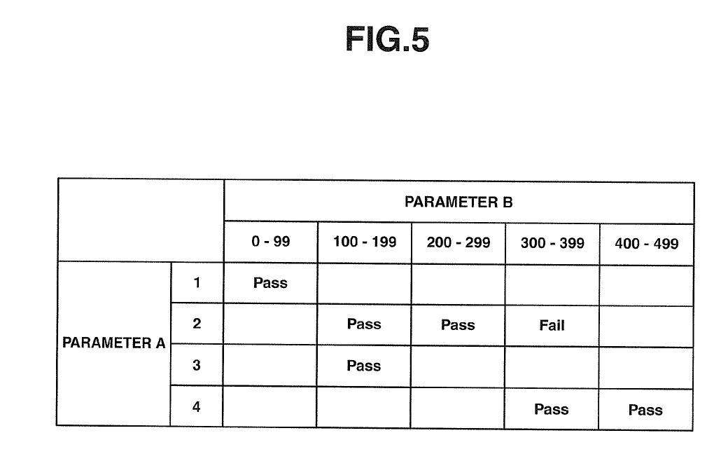

FIG. 5 is a diagram illustrating an example of the parameter table 327. FIG. 5 illustrates an example of a two-dimensional parameter table 327 generated when two types of parameters are provided. In FIG. 5, a parameter A, values of which are arranged in rows, indicates commands for a bus operation: the respective numerals correspond to individual commands in such a manner that “1” is “Read”, “2” is “Write” and so on. Also, in FIG. 5, a parameter B, values of which are arranged in columns, indicates addresses.

In the example in FIG. 5, addresses, which correspond to the parameter B, are divided into five ranges of 0 to 99, 100 to 199, 200 to 299, 300 to 399 and 400 to 499. Meanwhile, four commands are used for the parameter A. Accordingly, there are 20 (4×5) combinations of the respective commands of the parameter A and the respective divisional ranges of the parameter B.

“Pass” or “Fail” entered in each of some of cells in the parameter table 327 indicates a result of verification using each stimulus at a certain point of time during a simulation. For example, “Pass” in a cell in the first row and the first column (the left uppermost cell: hereinafter referred to as “cell (1, 1)”) indicates that a result of verification of a logic circuit 322 when a stimulus generated for a condition that the parameter A is “1” and parameter B is in the range of “0 to 99” is input is Pass.

Vacant cells indicate that verification has not been performed. For example, a cell (1, 5) (right uppermost cell) indicates that verification of the logic circuit 322 has not been performed for a condition that the parameter A is “1” and the parameter B is in the range of “400 to 499”.

Although in FIG. 5, the parameter table 327 is expressed in a form of a two-dimensional table where there are two types of parameters, the parameter table 327 is expressed by a three-dimensional table where there are three types of parameters, and is expressed by an n-dimensional matrix where there are n types of parameters. The parameter table 327 can not only be accessed by the stimulus control section 320, but also a content of the parameter table 327 may be viewed by, e.g., displaying the content on, e.g., a monitor or printing.

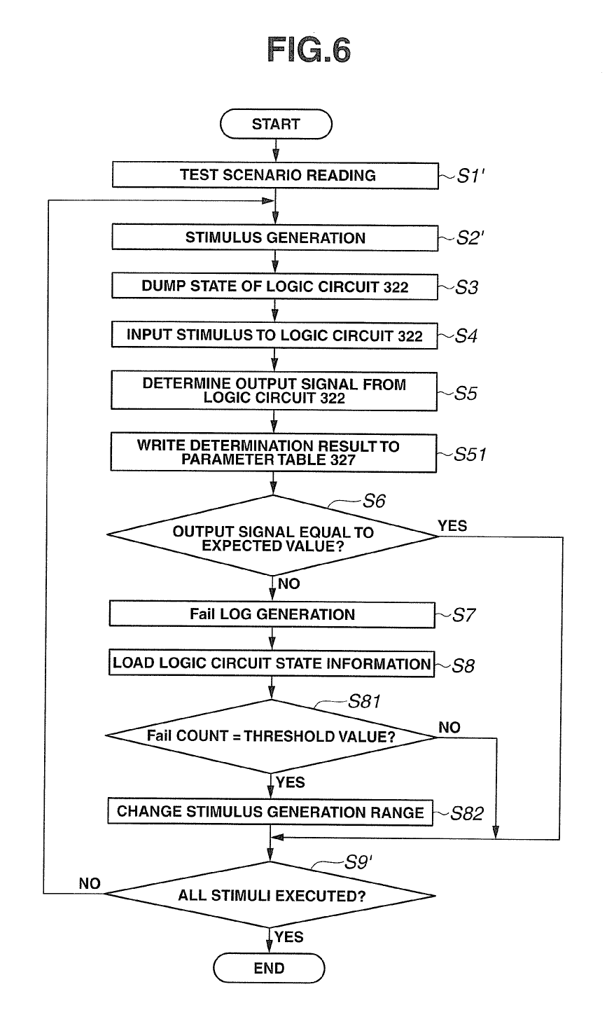

Next, an operation of a functional verification system 1 for a semiconductor integrated circuit according to the present embodiment will be described. FIG. 6 is a flowchart illustrating a specific procedure of functional verification of the logic circuit 322 performed by the functional verification system 1 according to the second embodiment. Steps are similar to those in the first embodiment illustrated in FIG. 3 and step numerals that are the same as those of the first embodiment.

First, in step S1′, the test scenario 31 is read to the stimulus control section 320 of the simulator 32. The stimulus control section 320 determines one or more types of parameters to be controlled, and possible values each of the parameters has, according to the read test scenario 31. Also, a matrix including the respective parameters as elements is created and held as a parameter table 327.

Next, the procedure proceeds to step S2′, and an instruction to generate a stimulus is input from the stimulus control section 320 to a stimulus generating section 321′. The stimulus generating section 321′ determines parameters according to a content of the instruction and generates a stimulus. Subsequently, a state of the logic circuit 322 (logic circuit state information) is dumped into a logic circuit state information storing section 33 (step S3).

Next, the stimulus generated in step S2′ is input from the stimulus generating section 321′ to the logic circuit 322 and the result determining section 323′ (step S4). A value of each of a signal, a resister and a memory element in the logic circuit 322 varies according to the content of the stimulus, and an output value is transmitted to the result determining section 323′. The result determining section 323′ compares the output value from the logic circuit 322 and an expected value generated based on the stimulus transmitted from the stimulus generating section 321′, to determine whether a result of the verification is Pass or Fail (step S5).

The result of determination by the result determining section 323′ and the content of the stimulus are output to the stimulus control section 320, and written to a relevant cell in the parameter table 327 (step S51). The cell in which the result of the verification is written is a cell corresponding to values of the parameters for the stimulus generated by the stimulus generating section 321′ in step S2′. For example, in step S2′, if the stimulus generating section 321′ determines that a value of the parameter A is “2” and a value of the parameter B is “150” and generates a stimulus based on such determination, a result of the verification is written to a cell (2, 2) in the parameter table 327 in FIG. 5 (In FIG. 5, the value “2” of the parameter A falls under the second row and the value “150” of the parameter B is included in the range of “100 to 199” and thus falls under the second column). For example, if the result of the verification is Pass, “Pass” is written in the cell (2, 2).

Next, in step S6, if a determination is made that the output value from the logic circuit 322 is different from the expected value, that is, the result of the verification is Fail, the procedure proceeds to step S7. In step S7, the result determining section 323′ instructs a Fail log generating section 326 to generate a Fail log. The Fail log generating section 326 describes information enabling identification of a situation when the Fail occurred, in the Fail log 34. Furthermore, the result determining section 323′ instructs a state loading section 325 to load the logic circuit state information. The state loading section 325 loads the logic circuit state information stored in the logic circuit state information storing section 33 into the logic circuit 322. In other words, with this step, the state of the logic circuit 322 returns to a state before the input of the stimulus that is a cause of the occurrence of the Fail.

Next, the procedure proceeds to step S81, the number of “Fail”s input in the parameter table 327 and a preset threshold value are compared. The threshold value is a value set as a trigger to change a range for generation of a stimulus in a following step, and set in the stimulus control section 320 in advance to the functional verification. The threshold value may be a fixed value or may be externally rewritten as necessary.

In step S81, if a determination is made that the number of “Fail”s is equal to the threshold value, the procedures proceeds to step S82, and a range for a stimulus to be generated subsequently (range of possible values each parameter has, which is used for generation of a stimulus).

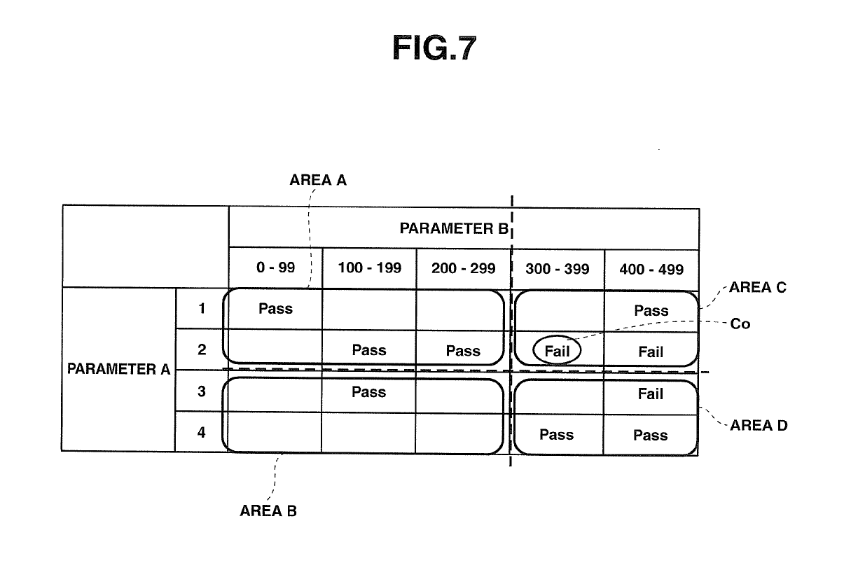

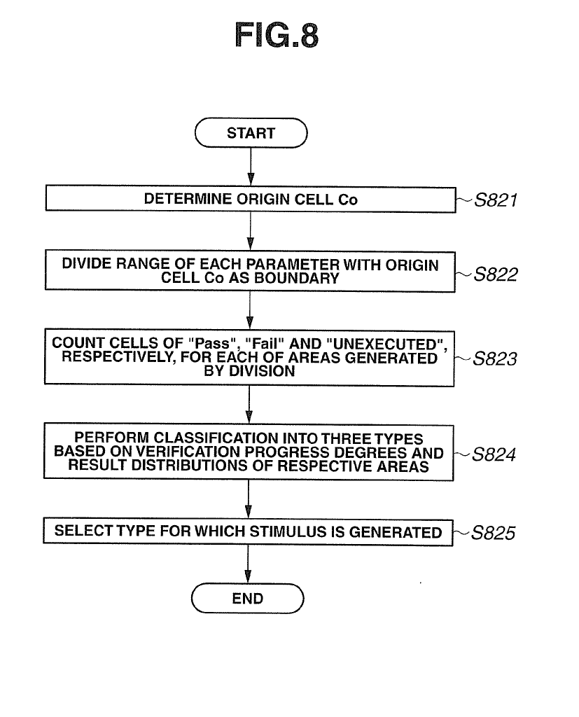

A method for changing a range for a stimulus will be described with reference to FIGS. 7 and 8. FIG. 7 is a diagram illustrating an example of the parameter table 327 at a certain point of time in a simulation. FIG. 8 is a flowchart illustrating an example of a procedure for changing a range for a stimulus. In other words, the procedure illustrated in FIG. 8 indicates an example of a specific example of step S82 in the flowchart in FIG. 6.

FIG. 7 illustrates the parameter table 327 at a point of time when ten stimuli were generated, verification was performed using such stimuli and the verification results have been written therein. From among the ten stimuli, the results of verification using seven stimuli are Pass, and the results of verification using three stimuli are Fail.

Here, it is assumed that a third Fail occurs as a result of verification being performed using a stimulus generated for a condition that the parameter A is “2” and the parameter B is “350”. In other words, it is assumed that the “Fail” written in the cell (2, 4) is the third “Fail” written in the parameter table 327. If the threshold value is “3”, the cell (2, 4) is an origin cell Co for changing a stimulus generation range (step S821).

With the origin cell Co as a boundary, the range of parameter A and the range of parameter B are divided respectively (step S822). In other words, the values of the parameter A are divided into “1” and “2”, and “3” and “4”. Also, the ranges of the parameter B are divided into a range of “0 to 99”, “100 to 199” and “200 to 299” and a range of “300 to 399” and “400 to 499”.

As a result of each of the parameter A and the parameter B being divided into two, the parameter table 327 is divided into four areas (2²=4). In other words, the parameter table 327 is divided into four areas: an area in which the parameter A is “1” or “2” and the parameter B are in the range of “0 to 99”, “100 to 199” and “200 to 299” (area A); an area in which the parameter A is “3” or “4” and the parameter B is in the range of “0 to 99”, “100 to 199” and “200 to 299” (area B); an area in which the parameter A is “1” or “2” and the parameter B is in the range of “300 to 399” and “400 to 499” (area C); and an areas in which the parameter A is “3” or “4” and the parameter B is in the range of “300 to 399” and “400 to 499” (area D).

Although the example illustrated in FIG. 7 indicates a case where two parameters are provided, where n parameters are provided, the parameter table 327 is divided into 2ⁿ areas.

For each of the areas resulting from the division, the number of “Pass”s and the number of “Fail”s written in cells in the area and the number of cells with nothing written therein are counted, respectively (step S823). For example, the area A includes three “Pass”s, no “Fail” and three unwritten cells, the area B includes one “Pass”, no “Fail” and five unwritten cells. The area C includes one “Pass”, two “Fail”s and one unwritten cell, and the area D includes two “Pass”s, one “Fail” and one unwritten cell.

Based on the above results, each of the areas is classified into any of three types: a type A (with a large number of “Pass” results); a type B (with a large number of “Fail” results); and a type C (with a large number of unwritten cells, i.e., verification has not so progressed) (step S824). In the case of the example illustrated in FIG. 7, the areas A and D are classified into the type A, the area B is classified into the type C, and the area C is classified into the type B.

Lastly, a type that is a target for verification is selected according to a purpose of subsequent functional verification, the range for generation of a stimulus is changed to area(s) classified into the selected type (step S825). For example, selection of each of the types only can be expected to provide the following advantages.

If only an area of the type A is selected and subsequent functional verification is performed for the area, the possibility that an effective search for a bug with a low probability of occurrence, which has not yet been detected, can be made is increased. If only an area of the type B is selected a region around a region where a bug with a high probability of occurrence been detected can be verified in detail. Furthermore, if only an area of the type C is selected, verification can be performed over an entire region of the space to be verified.

The type selection may be set in advance to the functional verification, or a type may be selected as needed, with reference to the parameter table 327 illustrated in FIG. 7 in which the results of functional verification in progress are entered. Alternatively, depending on conditions, a plurality of types may be selected.

In step S81, if a determination is made that the number of “Fail”s is not equal to the threshold value, the procedure proceeds to step S9′ without going through step S82. In other words, the stimulus generation range is not changed, and in the subsequent functional verification, a stimulus is generated for a range that is the same as that used for the previous verification.

In step S6, if a determination is made that the output value from the logic circuit 322 is equal to the expected value, that is, the result of the verification is Pass, the procedure processing to step S9′ without going through the steps from generation of a Fail log (step S7) to change of the stimulus generation range (step S82).

If there is an unexecuted stimulus from among stimuli to be generated based on the test scenario 31 (step S9′: No), the procedure returns to step S2′, the stimulus generating section 321′ generates an unexecuted new stimulus. If the range for generation of a stimulus is changed in step S82, whether or not all stimuli in the changed range have been executed is determined in step S9′. Also, if the range for generation of a stimulus is changed in step S82, a stimulus is generated only for the changed range in step S2′. Using the new stimulus generated in step S2′, the above-described procedure from steps S3 to S82 is performed, whereby functional verification of the logic circuit 322 is continuously performed.

On the other hand, if all of the stimuli generated based on the test scenario 31 have already been executed, the functional verification of the logic circuit 322 is terminated (step S9′: Yes).

As described above, in the present embodiment, the range for generation of a stimulus is changed with reference to results of functional verification in progress (distribution of “Pass” and “Fail” and the degree of bias in regions for which verification have been performed), and subsequent verification is performed only for a particular area, and thus, effective bug detection that meets a purpose can be performed, enabling further reduction in development time and cost.

While in the above-described embodiment, the range for generation of a stimulus is re-defined (limited) at a point of time of detection of a designated number of “Fail”s, arrangement may be made so that the range for generation of a stimulus is re-defined, for example, when the number of stimuli generated reaches a predetermined count. Also, it is possible that the re-definition (limitation) is performed not only once, but a plurality of times, for example, each time the number of stimuli generated reaches a multiple of ten.

Furthermore, while in the example illustrated in FIG. 5, a range of possible values (0 to 499) the parameter B has is divided into five regions for generation of stimuli and writing of verification results, the division can freely be changed according to, e.g., the purpose and precision of the verification. Accordingly, the range may be divided into a number of regions that is larger than the five regions (for example, ten regions), or may also be divided into a number of regions that is smaller than the five regions (for example, four regions).

While certain embodiments have been described, these embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. A functional verification system for a semiconductor integrated circuit, the system comprising:
a stimulus generating module configured to generate a stimulus according to an input test scenario;
a result determining module configured to compare an output value obtained by the stimulus being input to a logic circuit to be verified and a predetermined operation being thereby performed, and an expected value expected to be obtained where the stimulus is input to the logic circuit to be verified and a predetermined operation is thereby performed, to determine whether or not the output value and the expected value correspond to each other;
a state dumping module configured to store values of all signals, registers and memory elements in the logic circuit to be verified, in a storing device as logic circuit state information at an arbitrary point of time from the generation of the stimulus to the input of the stimulus to the logic circuit to be verified; and
a state loading module configured to load the logic circuit state information stored in the storing device into the logic circuit to be verified,
wherein the state loading module loads the logic circuit state information into the logic circuit to be verified only if the result determining module determines that the output value and the expected value do not correspond to each other.

2. The functional verification system for a semiconductor integrated circuit of claim 1, further comprising a fail log generating module configured to, if the result determining module determines that the output value and the expected value do not correspond to each other, output information on the non-correspondence as a log, the information including at least the stimulus, the expected value and the output value.

3. The functional verification system for a semiconductor integrated circuit of claim 2, wherein the state loading module loads the logic circuit state information into the logic circuit to be verified only if the result determining module determines that the output value and the expected value do not correspond to each other, to return the logic circuit to be verified to a state before the input and execution of the stimulus in the logic circuit to be verified, and after loading of the logic circuit state information into the logic circuit to be verified, the stimulus generating module generates a second stimulus that is different from the stimulus and inputs the second stimulus to the logic circuit to be verified.

4. The functional verification system for a semiconductor integrated circuit of claim 1, further comprising a stimulus generation control module configured to determine one or more types of parameters included in the stimulus generated according to the test scenario and a possible value or a possible range each of the parameters has, and create and hold a parameter table including the parameters as axes and combinations of the possible values or the possible ranges of the parameters as elements,
wherein the stimulus generation control module registers a determination result obtained by the result determining module as a result of the stimulus being input to the logic circuit to be verified, in an element used for generation of the stimulus in the parameter table, and divides the parameter table into a plurality of areas with the element with the determination result registered therein as a boundary, at a certain set point of time.

5. The functional verification system for a semiconductor integrated circuit of claim 4, wherein the stimulus generation control module extracts the region meeting a specific condition from the plurality of regions resulting from the parameter table being divided, and sets a value of each of the parameters used for generation of the stimulus used for subsequent verification, to a value included in the extracted region.

6. The functional verification system for a semiconductor integrated circuit of claim 5, wherein from among the plurality of regions resulting from the parameter table being divided, the stimulus generation control module classifies a region in which a number of elements with a determination result not registered therein is largest into a first type, a region in which a number of elements with a determination result of the output value and the expected value not corresponding to each other registered therein is largest into a second type, and a region in which a number of elements with a determination result of the output value and the expected value corresponding to each other registered therein is largest into a third type, and extracts the region with classification of the region into a certain type from among the first to third types as the specific condition.

7. The functional verification system for a semiconductor integrated circuit of claim 6, further comprising a fail log generating module configured to, if the result determining module determines that the output value and the expected value do not correspond to each other, output information on the non-correspondence as a log, the information including at least the stimulus, the expected value and the output value.

8. A functional verification method for a semiconductor integrated circuit, the method comprising:
generating a stimulus according to an input test scenario;
storing values of all signals, registers and memory elements in a logic circuit to be verified, in a storing device as logic circuit state information at an arbitrary point of time from the generation of the stimulus to an input of the stimulus to the logic circuit to be verified;
comparing an output value obtained by the stimulus being input to the logic circuit to be verified and a predetermined operation being thereby performed, and an expected value expected to be obtained where the stimulus is input to the logic circuit to be verified and a predetermined operation is thereby performed, to determine whether or not the output value and the expected value correspond to each other; and
loading the logic circuit state information into the logic circuit to be verified only if a determination is made that the output value and the expected value do not correspond to each other.

9. The functional verification method for a semiconductor integrated circuit of claim 8, further comprising loading the logic circuit state information into the logic circuit to be verified only if a determination is made that the output value and the expected value do not correspond to each other, to return the logic circuit to be verified to a state before the input and execution of the stimulus in the logic circuit to be verified, and after loading of the logic circuit state information into the logic circuit to be verified, generating a second stimulus that is different from the stimulus and inputting the second stimulus to the logic circuit to be verified.

10. The functional verification method for a semiconductor integrated circuit of claim 8, further comprising, if a determination is made that the output value and the expected value do not correspond to each other, outputting information on the non-correspondence as a log, the information including at least the stimulus, the expected value and the output value.

11. The functional verification method for a semiconductor integrated circuit of claim 10, further comprising loading the logic circuit state information into the logic circuit to be verified only if a determination is made that the output value and the expected value do not correspond to each other, to return the logic circuit to be verified to a state before the input and execution of the stimulus in the logic circuit to be verified, and after loading of the logic circuit state information into the logic circuit to be verified, generating a second stimulus that is different from the stimulus and inputting the second stimulus to the logic circuit to be verified.

12. A functional verification method for a semiconductor integrated circuit, the method comprising:
determining one or more types of parameters included in a stimulus generated according to an input test scenario and a possible value or a possible range each of the parameters has, and generating a parameter table including the parameters as axes and combinations of the values or the ranges of the parameters as elements;
generating a stimulus according to the test scenario;
storing values of all signals, registers and memory elements in a logic circuit to be verified, in a storing device as logic circuit state information at an arbitrary point of time from the generation of the stimulus to the input of the stimulus to the logic circuit to be verified;
comparing an output value obtained by the stimulus being input to the logic circuit to be verified and a predetermined operation being thereby performed, and an expected value expected to be obtained where the stimulus is input to the logic circuit to be verified and a predetermined operation is thereby performed, to determine whether or not the output value and the expected value correspond to each other;
registering a result of the determination in the element used for generation of the stimulus in the parameter table; and
loading the logic circuit state information into the logic circuit to be verified only if a determination is made that the output value and the expected value do not correspond to each other.

13. The functional verification method for a semiconductor integrated circuit of claim 12, further comprising, if a determination is made that the output value and the expected value do not correspond to each other, outputting information on the non-correspondence as a log, the information including at least the stimulus, the expected value and the output value.

14. The functional verification method for a semiconductor integrated circuit of claim 13, further comprising loading the logic circuit state information into the logic circuit to be verified only if a determination is made that the output value and the expected value do not correspond to each other, to return the logic circuit to be verified to a state before the input and execution of the stimulus in the logic circuit to be verified, and after loading of the logic circuit state information into the logic circuit to be verified, generating a second stimulus that is different from the stimulus and inputting the second stimulus to the logic circuit to be verified.

15. The functional verification method for a semiconductor integrated circuit of claim 14, further comprising, if a determination is made that the output value and the expected value do not correspond to each other, counting a number of elements with a determination result of the output value and the expected value not corresponding to each other registered therein in the parameter table, and if the number of elements corresponds to a preset threshold value, changing a range for generation of the second stimulus.

16. The functional verification method for a semiconductor integrated circuit of claim 12, further comprising dividing the parameter table into a plurality of regions with an element with the determination result registered at a certain set point of time as a boundary.

17. The functional verification method for a semiconductor integrated circuit of claim 12, further comprising, if a determination is made that the output value and the expected value do not correspond to each other, counting the number of elements with the determination result of the output value and the expected value not corresponding each other registered therein in the parameter table, and if the number of elements corresponds to a preset threshold value, dividing the parameter table into a plurality of regions with an element with the determination result registered therein as a boundary.

18. The functional verification method for a semiconductor integrated circuit of claim 16, further comprising extracting a region meeting a specific condition from the plurality of regions resulting from the parameter table being divided, and setting a value of each of the parameters used for generation of the stimulus used for subsequent verification, to a value included in the extracted region.

19. The functional verification method for a semiconductor integrated circuit of claim 18, further comprising, from among the plurality of regions resulting from the parameter table being divided, classifying a region in which a number of elements with a determination result not registered therein is largest into a first type, a region in which a number of elements with a determination result of the output value and the expected value not corresponding to each other registered therein is largest into a second type, and a region in which a number of elements with a determination result of the output value and the expected value corresponding to each other registered therein is largest into a third type, and extracting the region with classification of the region into a certain type from among the first to third types as the specific condition.

20. The functional verification method for a semiconductor integrated circuit of claim 19, further comprising, if a determination is made that the output value and the expected value do not correspond to each other, outputting information on the non-correspondence as a log, the information including at least the stimulus, the expected value and the output value.
